(19) United States
(12) Patent Application Publication
(10) Pub. No.: US 2005/0102476 A1
(43) Pub. Date: May 12, 2005

(54) Random access memory with optional column address strobe latency of one

(75) Inventor: Torsten Partsch, Raleigh, NC (US)

Correspondence Address: Dicke, Billig & Czaja, PLLC;Fifth Street Towers, Suite 2250, 100 South Fifth Street, Minneapolis, MN, 55402, US

(73) Assignee: Infineon Technologies North America Corp.

(21) Appl. No.: 10/706,438

(22) Filed: Nov. 12, 2003

(51) Int. Cl. G06F 13/28

(52) U.S. Cl. 711/138

(57) ABSTRACT

A random access memory comprises an array of memory cells, a memory configured to receive data from the array of memory cells, a bypass circuit configured to receive the data from the array of memory cells and to bypass the memory, and a circuit configured to select between receiving the data from the memory to provide first output signals and receiving the data from the bypass circuit to provide second output signals based on a column address strobe latency signal.

### BACKGROUND

One type of memory known in the art is double data rate synchronous dynamic random access memory (DDR SDRAM). In general, DDR SDRAM includes at least one array of memory cells. The memory cells are arranged in rows and columns, with the rows extending along an x-direction and the columns extending along a y-direction. Conductive word lines extend across the array of memory cells along the x-direction and conductive bits lines extend across the array of memory cells along the y-direction. A memory cell is located at each cross point of a word line and a bit line. Memory cells are accessed using a row address and a column address.

A column address strobe (CAS) is used to latch in the column address for a selected memory cell during a read or write operation. CAS latency is the time between the initialization of a read command and the data being available on the output pads or pins of a memory. CAS latency is specified in clock cycles. The CAS latency for a DDR SDRAM is typically configurable, but cannot be lower than the minimum CAS latency specified for a particular DDR SDRAM.

DDR SDRAM typically has a minimum CAS latency of two or more. A CAS latency of two or more is used since a rising clock edge is required to strobe read data out of the memory and a rising clock edge is normally not available until the next clock cycle after the clock cycle that initiates a read operation.

One type of DDR SDRAM is Mobile DDR SDRAM. Mobile DDR SDRAM is a new generation of low power SDRAM designed especially for mobile applications. Mobile DDR SDRAM achieves high speed data transfer rates by employing a chip architecture that prefetches multiple bits and provides the output data to an external device. Mobile DDR SDRAM typically has a minimum CAS latency of two or more. Shorter data transfer access times can be achieved with a CAS latency of one.

### SUMMARY

One aspect of the present invention provides a random access memory. The random access memory comprises an array of memory cells, a memory configured to receive data from the array of memory cells, a bypass circuit configured to receive the data from the array of memory cells and to bypass the memory, and a circuit configured to select between receiving the data from the memory to provide first output signals and receiving the data from the bypass circuit to provide second output signals based on a column address strobe latency signal.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a block diagram illustrating an exemplary embodiment of a random access memory, according to the present invention.

FIG. 2 is a diagram illustrating an exemplary embodiment of a memory cell.

FIG. 3 is a block diagram illustrating an exemplary embodiment of an output circuit that provides a CAS latency of one option.

FIG. 4 is a block diagram illustrating another exemplary embodiment of an output circuit that provides a CAS latency of one option.

FIG. 5 is a timing diagram illustrating signal timing for the output circuits.

### DETAILED DESCRIPTION

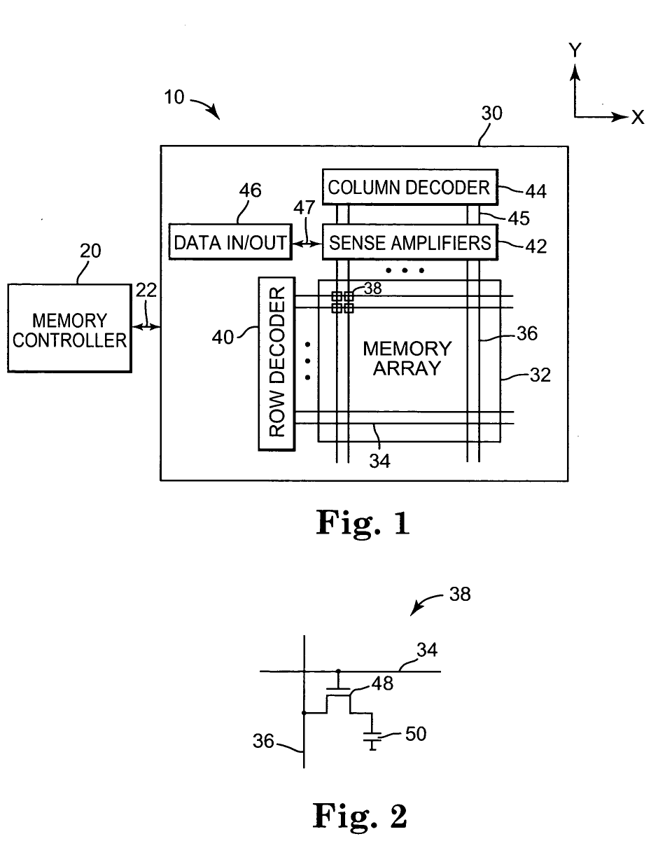

FIG. 1 is a block diagram illustrating a random access memory 10. In one embodiment, random access memory 10 is a double data rate synchronous dynamic random access memory (DDR SDRAM). The DDR SDRAM 10 includes a memory controller 20 and at least one memory bank 30. Memory bank 30 includes an array of memory cells 32, a row decoder 40, a column decoder 44, sense amplifiers 42, and data in/out circuit 46. Memory controller 20 is electrically coupled to memory bank 30, indicated at 22.

Conductive word lines 34, referred to as row select lines, extend in the x-direction across the array of memory cells 32. Conductive bit lines 36, referred to as column select lines, extend in the y-direction across the array of memory cells 32. A memory cell 38 is located at each cross point of a word line 34 and a bit line 36. Each word line 34 is electrically coupled to row decoder 40 and each bit line 36 is electrically coupled to a sense amplifier 42. The sense amplifiers 42 are electrically coupled to column decoder 44 through conductive column decoder lines 45 and to data in/out circuit 46 through data lines 47.

Data in/out circuit 46 includes a plurality of latches and data input/output (I/O) pads or pins (DQs) to transfer data between memory bank 30 and an external device. In one embodiment, there is one data in/out circuit 46 for all memory banks. In another embodiment, there is one data in/out circuit 46 for every memory bank or groups of memory banks. Data written into memory bank 30 is presented as voltages on the DQs from an external device. The voltages are translated into the appropriate logic levels and stored in selected memory cells 38. Data read from memory bank 30 is presented by memory bank 30 on the DQs for an external device to retrieve. Data read from selected memory cells 38 appears at the DQs once access is complete and the output is enabled. At other times, the DQs are in a high impedance state.

Data in/out circuit 46 includes a first in/first out (FIFO) memory block and a bypass around the FIFO memory block. The bypass is electrically coupled between the data lines 47 and each DQ. During a read operation, data passes through the FIFO memory block for a column address strobe (CAS) latency greater than one and through the bypass around the FIFO memory block for a CAS latency of one.

Memory controller 20 controls reading data from and writing data to memory bank 30. During a read operation, memory controller 20 passes the row address of a selected memory cell or cells 38 to row decoder 40. Row decoder 40 activates the selected word line 34. As the selected word line 34 is activated, the value stored in each memory cell 38 coupled to the selected word line 34 is passed to the respective bit line 36. The value of each memory cell 38 is read by a sense amplifier 42 electrically coupled to the respective bit line 36. Memory controller 20 passes a column address of the selected memory cell or cells 38 to column decoder 44. Column decoder 44 selects which sense amplifiers 42 pass data to data in/out circuit 46 for retrieval by an external device.

During a write operation, the data to be stored in array 32 is placed in data in/out circuit 46 by an external device. Memory controller 20 passes the row address for the selected memory cell or cells 38 where the data is to be stored to row decoder 40. Row decoder 40 activates the selected word line 34. Memory controller 20 passes the column address for the selected memory cell or cells 38 where the data is to be stored to column decoder 44. Column decoder 44 selects which sense amplifiers 42 are passed the data from data in/out circuit 46. Sense amplifiers 42 write the data to the selected memory cell or cells 38 through bit lines 36.

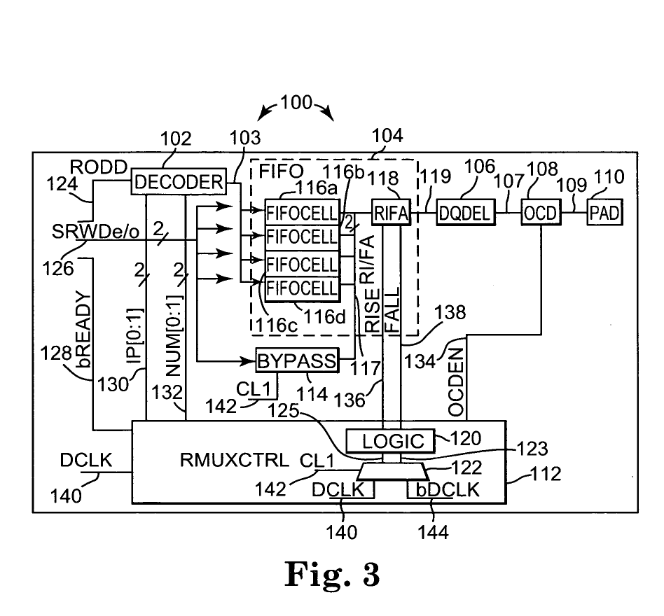

FIG. 2 illustrates an exemplary embodiment of one memory cell 38 in the array of memory cells 32. Memory cell 38 includes a transistor 48 and a capacitor 50. The gate of transistor 48 is electrically coupled to word line 34. The drain-source path of transistor 48 is electrically coupled to bit line 36 and capacitor 50. Capacitor 50 is charged to represent either a logic 0 or a logic 1. During a read operation, word line 34 is activated to turn on transistor 48 and the value stored on capacitor 50 is read by a corresponding sense amplifier 42 through bit line 36 and transistor 48. During a write operation, word line 34 is activated to turn on transistor 48 and the value stored on capacitor 50 is written by a corresponding sense amplifier 42 through bit line 36 and transistor 48.

The read operation on memory cell 38 is a destructive read operation. After each read operation, capacitor 50 is recharged with the value that was just read. In addition, even without read operations, the charge on capacitor 50 discharges over time. To retain a stored value, memory cell 38 is refreshed periodically by reading or writing the memory cell 38. All memory cells 38 within the array of memory cells 32 are periodically refreshed to maintain their values.

In DDR SDRAM, the read and write operations are synchronized to a system clock. The system clock is supplied by a host system that includes the DDR SDRAM 10. DDR SDRAM operates from a differential clock, CK and bCK. The crossing of CK going high and bCK going low is referred to as the positive edge of CK. Commands such as read and write operations, including address and control signals, are registered at the positive edge of CK. Operations are performed on both the rising and falling edges of the system clock.

The DDR SDRAM uses a double data rate architecture to achieve high speed operation. The double data rate architecture is essentially a 2n prefetch architecture with an interface designed to transfer two data words per clock cycle at the DQs. A single read or write access for the DDR SDRAM effectively consists of a single 2n bit wide, one clock cycle data transfer at the internal memory array and two corresponding n bit wide, one half clock cycle data transfers at the DQs.

A bidirectional data strobe (DQS) is transmitted along with data for use in data capture at data in/out circuit 46. DQS is a strobe transmitted by the DDR SDRAM during read operations and by the memory controller, such as memory controller 20, during write operations. DQS is edge aligned with data for read operations and center aligned with data for write operations. Input and output data is registered on both edges of DQS.

Read and write accesses to the DDR SDRAM are burst oriented. Accesses start at a selected location and continue for a programmed number of locations in a programmed sequence. Accesses begin with the registration of an active command, which is followed by a read or write command. The address bits registered coincident with the active command are used to select the bank and row to be accessed. The address bits registered coincident with the read or write command are used to select the bank and the starting column location for the burst access.

The DDR SDRAM in the preceding description is referred to as DDR-I SDRAM for being the first generation of DDR SDRAM. The next generation of DDR SDRAM, DDR-II SDRAM has the same features as DDR-I SDRAM except that the data rate is doubled. The DDR-II SDRAM architecture is essentially a 4n prefetch architecture with an interface designed to transfer four data words per clock cycle at the DQs. A single read or write access for the DDR-II SDRAM effectively consists of a single 4n bit wide, one clock cycle data transfer at the internal memory array and four corresponding n bit wide, one quarter clock cycle data transfers at the DQs. In one embodiment, DDR SDRAM 10 is a DDR-II SDRAM.

Mobile DDR SDRAM is a new generation of low power DDR SDRAM designed especially for mobile applications. Mobile DDR SDRAM achieves high speed data transfer rates by employing a chip architecture that prefetches multiple bits and provides the output data to an external device. Mobile DDR SDRAM can include DDR-I SDRAM or DDR-II SDRAM.

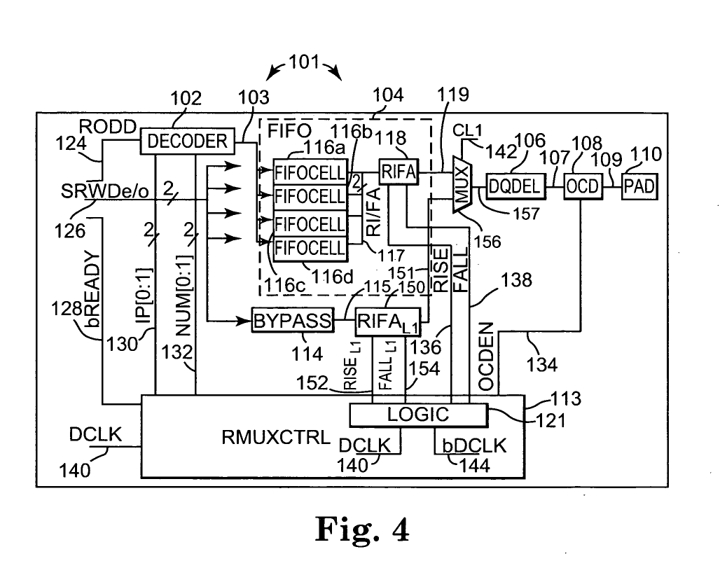

FIG. 3 is a block diagram illustrating an exemplary embodiment of an output circuit 100 that provides a CAS latency of one option. Output circuit 100 is a portion of data in/out circuit 46. Output circuit 100 illustrates the circuit for a single DQ. In DDR SDRAM 10, the number of circuits 100 equals the number of DQs. Output circuit 100 includes a decoder 102, a first in/first out (FIFO) memory block 104, a DQ delay (DQDEL) 106, an off chip driver (OCD) 108, an I/O pad (DQ) 110, a read multiplexer controller (RMUXCTRL) 112, and a bypass circuit 114. FIFO memory block 104 includes FIFO cells 116a-116d and rise/fall (RIFA) circuit 118. Read multiplexer controller 112 includes logic block 120 and multiplexer 122.

FIFO cells 116a-116d and bypass 114 are electrically coupled to RIFA 118 through data path 117. Decoder 102 is electrically coupled to FIFO memory block 104 through control path 103 and to read multiplexer controller 112 through input pointer (IP[0:1]) path 130 and output pointer (NUM[0:1]) path 132. FIFO memory block 104 is electrically coupled to DQ delay 106 through data path 119. DQ delay 106 is electrically coupled to off chip driver 108 through data path 107. Off chip driver 108 is electrically coupled to pad (DQ) 110 through data path 109. Read multiplexer controller 112 is electrically coupled to RIFA 118 of FIFO memory block 104 through control signal paths RISE 136 and FALL 138. Read multiplexer controller 112 is electrically coupled to off chip driver 108 through off chip driver enable control signal (OCDEN) path 134. Read multiplexer controller 112 is configured to control one or more FIFO memory blocks. In one embodiment, read multiplexer controller 112 controls all of the FIFO memory blocks.

The RODD signal on signal path 124 is an input to decoder 102 and indicates whether the first read burst of data started at an even or an odd column address. The shared read write data (SRWDe/o) signals are provided to FIFO memory block 104 and bypass 114 on data line 126 and pass data signals to and from memory array 32. The bReady signal on signal path 128 is a handshaking signal from memory bank 30 and is provided to read multiplexer controller 112. The bReady signal is used to indicate that the data on SRWDe/o data line 126 is available and ready to load into FIFO memory block 104 or to pass through bypass 114.

Input pointer (IP[0:1]) and output pointer (NUM[0:1]) are output signals from read multiplexer controller 112 and inputs to decoder 102 for controlling the loading of FIFO cells 116a-116d with data from SRWDe/o data line 126. Off chip driver enable signal (OCDEN) is an output from read multiplexer controller 112 and an input to off chip driver 108 to enable the off chip driver, which passes data from DQ delay 106 to pad 110 for retrieval by an external device. Internal data clock (DCLK) on path 140, derived from a system clock, is an input into read multiplexer controller 112 for use in timing operations of output circuit 100.

CAS latency one select (CL1) line 142 is electrically coupled to bypass 114 and multiplexer 122. Signal CL1 is true if a CAS latency of one is selected. CL1 is false if a CAS latency greater than one is selected.

Multiplexer 122 includes select input CL1 and inputs DCLK, and inverted DCLK (bDCLK) on path 144. Multiplexer 122 is electrically coupled to logic block 120 through multiplexer output paths 123 and 125. Logic block 120 generates a RISE signal and a FALL signal, which are both inputs to RIFA 118. If CL1 is true, the RISE signal follows bDCLK and the FALL signal follows DCLK. If CL1 is false, the RISE signal follows DCLK and the FALL signal follows bDCLK.

If CL1 is true, bypass 114 receives data from SRWDe/o data line 126 and passes the data to RIFA 118 bypassing FIFO cells 116a-116d. The output of bypass 114 is tri-state. The data is output one bit at a time to DQ delay 106 through RIFA 118 on each rising edge of the RISE signal and on each rising edge of the FALL signal. DQ delay 106 can delay passing the data received from RIFA 118 to adjust the timing of the output of the data to pad 110.

If CL1 is false, the output of bypass 114 is put in a high impedance state and the data passes normally through FIFO cells 116a-116d. FIFO cells 116a-116d temporarily hold data for outputting one bit at a time to DQ delay 106 through RIFA 118 on each rising edge of the RISE signal and on each rising edge of the FALL signal. DQ delay 106 can delay passing the data received from RIFA 118 to adjust the timing of the output of the data to pad 110.

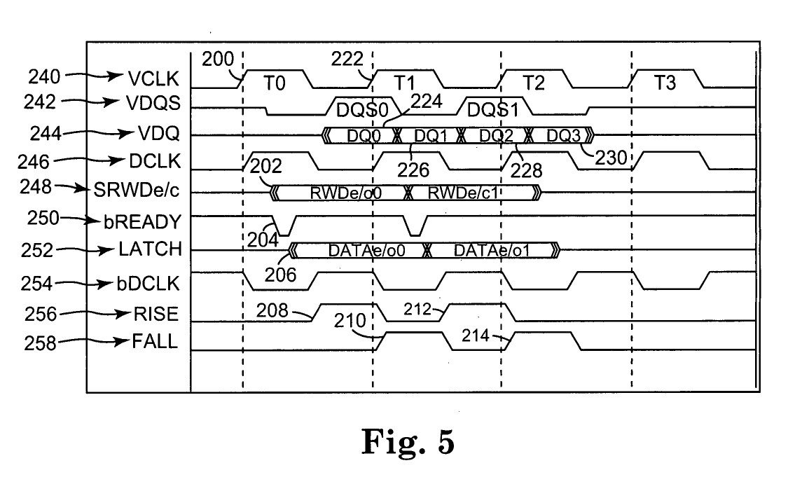

FIG. 4 is a block diagram illustrating another exemplary embodiment of an output circuit 101 that provides a CAS latency of one option. Output circuit 101 includes the same elements as output circuit 100 with the exception of read multiplexer controller 113 replacing read multiplexer controller 112 and the addition of RIFA_{L1} circuit 150 and multiplexer (MUX) 156. Logic block 121 in read multiplexer controller 113 replaces logic block 120 and multiplexer 122 in read multiplexer controller 112.

DCLK signal path 140 and bDCLK signal path 144 are electrically coupled to logic block 121. Logic block 121 is electrically coupled to RIFA_{L1} 150 through RISE_{L1} signal path 152 and FALL_{L1} signal path 154 and to RIFA 118 through RISE signal path 136 and FALL signal path 138. Multiplexer 156 is electrically coupled to RIFA 118 through data path 119, RIFA_{L1} 150 through data path 151, and DQ delay 106 through data path 157. RIFA_{L1} 150 is electrically coupled to bypass 114 through data path 115.

CL1 is an input to multiplexer 156. Read multiplexer controller 113 provides the RISE_{L1} signal and the FALL_{L1} signal to RIFA_{L1} 150. The RISE_{L1} signal follows bDCLK and the FALL_{L1} signal follows DCLK. The rising edge of the RISE_{L1} signal and the rising edge of the FALL_{L1} signal strobe out data one bit at a time from bypass 114 to multiplexer 156 through RIFA_{L1} 150. Read multiplexer controller 113 provides the RISE signal and the FALL signal to RIFA₁ 118. The RISE signal follows DCLK and the FALL signal follows bDCLK. The rising edge of the RISE signal and the rising edge of the FALL signal strobe out data one bit at a time from FIFO memory block 104 to multiplexer 156 through RIFA 118. Multiplexer 156 passes the data from RIFA_{L1} 150 if CL1 is true and the data from RIFA 118 if CL1 is false.

In this embodiment, if CL1 is true, the data passes through bypass 114 around FIFO memory block 104 to RIFA_{L1} 150. The RISE_{L1} signal and the FALL_{L1} signal are used to strobe the data out to multiplexer 156 where the data passes through to DQ delay 106. If CL1 is false, the data passes through FIFO cells 116a-116d to RIFA 118. The RISE signal and the FALL signal are used to strobe the data out to multiplexer 156 where the data passes through to DQ delay 106. This embodiment avoids multiplexing the DCLK signal, thereby avoiding changes to the timing of memory accesses for CAS latencies greater than one.

FIG. 5 is a timing diagram illustrating signal timing for output circuits 100 and 101 with a CAS latency of one selected. The output signal VDQ at 244 on pad 110 includes a burst length of four data bits, 224, 226, 228, and 230. A read command is initiated at the rising edge of VCLK 240 at 200. The read data SRWDe/o 248 on data line 126 is available at 202. The memory supplies bREADY signal 250 and a bREADY pulse at 204. The bREADY pulse at 204 latches the data at 206 into a latch, indicated at 252, which is the FIFO memory block 104 input. The data (DQ0) at 224 is strobed out on VDQ 244 starting on the rising edge 208 of the RISE signal 256 that is generated from bDCLK 254. The bDCLK signal 254 is the inverse of DCLK 246. The RISE signal is the multiplexed RISE signal on path 136 in output circuit 100 and the RISE_{L1} signal on path 152 in output circuit 101.

The CAS latency is one as data is strobed out before the second rising edge of VCLK 240 at 222. On the rising edge 210 of the FALL signal 258, DQ1 226 is strobed out to pad 110. The FALL signal illustrated is the multiplexed FALL signal on path 138 in output circuit 100 and the FALL_{L1} signal on path 154 in output circuit 101. DQ2 228 is strobed out on the rising edge 212 of the RISE signal 256 and DQ3 230 is strobed out on the rising edge 214 of the FALL signal 258. The transitions of VDQS 242 notify an external device that valid data is present on the DQ and should be retrieved before the next transition of VDQS 242.

The embodiments of the invention illustrated and described provide a CAS latency of one option. In DDR SDRAM, including DDR-I SDRAM, DDR-II SDRAM, and Mobile DDR SDRAM, a CAS latency of one can be provided using the circuits and methods described herein.

1. A random access memory, comprising:
an array of memory cells;
a memory configured to receive data from the array of memory cells;
a bypass circuit configured to receive the data from the array of memory cells and to bypass the memory; and
a circuit configured to select between receiving the data from the memory to provide first output signals and receiving the data from the bypass circuit to provide second output signals based on a column address strobe latency signal.

2. The random access memory of claim 1, wherein the circuit is configured to receive the data from the bypass circuit and provide the second output signals if the column address strobe latency signal indicates a column address strobe latency value of one.

3. The random access memory of claim 1, wherein the circuit is configured to receive the data from the memory and provide the first output signals if the column address strobe latency signal indicates a column address strobe latency value of greater than one.

4. The random access memory of claim 1, wherein the circuit comprises a first circuit configured to receive first rise and fall signals to serialize the data from the memory.

5. The random access memory of claim 4, wherein the circuit is configured to provide the first rise and fall signals after a first clock cycle is completed following a read command that is initiated by a first edge of the first clock cycle.

6. The random access memory of claim 4, wherein the circuit comprises a second circuit configured to receive second rise and fall signals to serialize the data from the bypass circuit.

7. The random access memory of claim 6, wherein the circuit is configured to provide the first rise and fall signals after a first clock cycle is completed following a read command that is initiated by a first edge of the first clock cycle and the second rise and fall signals during the first clock cycle.

8. The random access memory of claim 6, wherein the circuit comprises a multiplexer configured to select between serialized data from the first circuit and serialized data from the second circuit based on the column address strobe latency signal.

9. The random access memory of claim 1, wherein the circuit comprises a rise and fall circuit configured to receive first rise and fall signals to serialize the data from the memory and to receive second rise and fall signals to serialize the data from the bypass circuit.

10. The random access memory of claim 9, wherein the circuit is configured to select between providing the first rise and fall signals and providing the second rise and fall signals based on the column address strobe latency signal.

11. The random access memory of claim 10, wherein the circuit is configured to provide the first rise and fall signals after a first clock cycle is completed following a read command that is initiated by a first edge of the first clock cycle and the second rise and fall signals during the first clock cycle.

12. The random access memory of claim 1, wherein the bypass circuit is configured to tri-state an output if the column address strobe latency signal indicates a column address strobe latency value of greater than one.

13. The random access memory of claim 1, wherein the memory comprises a first in/first out memory.

14. The random access memory of claim 1, wherein the random access memory is a low power synchronous dynamic random access memory.

15. The random access memory of claim 1, wherein the random access memory is a double data rate-I synchronous dynamic random access memory.

16. The random access memory of claim 1, wherein the random access memory is a double data rate-II synchronous dynamic random access memory.

17. A random access memory, comprising:
a first in/first out memory;
a bypass circuit that bypasses the first in/first out memory; and
a control circuit configured to provide first signals and second signals, wherein the first signals latch data from the first in/first out memory to provide a column address strobe latency of greater than one and the second signals latch data from the bypass circuit to provide a column address strobe latency of one.

18. The random access memory of claim 17, wherein the control circuit comprises a clock signal multiplexer configured to select between providing the first signals and the second signals based on a column address strobe latency signal.

19. The random access memory of claim 17, comprising a rise/fall circuit configured to receive the first signals and the second signals to provide one data bit at a time.

20. The random access memory of claim 19, wherein the control circuit is configured to provide the first signals comprising a first rise signal and a first fall signal that is the inverse of the first rise signal and the second signals comprising a second rise signal and a second fall signal that is the inverse of the second rise signal.

21. The random access memory of claim 20, wherein the rise/fall circuit is configured to provide a first data bit as output on a rising edge of the first rise signal and a second data bit as output on a rising edge of the first fall signal.

22. The random access memory of claim 19, comprising a data delay circuit electrically coupled to the rise/fall circuit and configured to adjust output timing of the data.

23. The random access memory of claim 22, comprising an off chip driver configured to pass data from the data delay circuit to a data pad.

24. The random access memory of claim 17, wherein the bypass comprises a tri-state output that is set to a high impedance state for the column address strobe latency of greater than one.

25. A random access memory, comprising:
a memory circuit;
a bypass circuit configured to bypass the memory circuit;
a first rise/fall circuit configured to receive data from the memory circuit to provide a first output signal;
a second rise/fall circuit configured to receive data from the bypass circuit to provide a second output signal; and
a multiplexer configured to select between the first output signal and the second output signal based on a column address strobe latency signal.

26. The random access memory of claim 25, wherein the multiplexer selects the first output signal if the column address strobe latency signal indicates the column address strobe latency is greater than one and the second output signal if the column address strobe latency signal indicates the column address strobe latency is one.

27. The random access memory of claim 25, comprising a controller configured to provide a first signal and a second signal to the first rise/fall circuit and a third signal and a fourth signal to the second rise/fall circuit.

28. The random access memory of claim 27, wherein the controller is configured to create the first signal and the second signal from a clock signal and the third signal and the fourth signal from the inverted clock signal.

29. The random access memory of claim 28, wherein the first rise/fall circuit outputs a first data bit on a rising edge of the first signal and a second data bit on a rising edge of the second signal.

30. The random access memory of claim 28, wherein the second rise/fall circuit outputs a first data bit on a rising edge of the third signal and a second data bit on a rising edge of the fourth signal.

31. A random access memory comprising:
means for storing data read from an array of memory cells;
means for receiving the data read from the array of memory cells to bypass the means for storing data;
means for retrieving the data from the means for storing the data if column address strobe latency is greater than one;
means for retrieving the data from the means for receiving the data if the column address strobe latency is one.

32. The random access memory of claim 31, wherein the means for storing data comprises a first in/first out memory.

33. The random access memory of claim 31, comprising means for serializing the data retrieved from the means for storing and the means for receiving to provide serial data bit output signals.

34. A method for reading data from a random access memory in a column address strobe latency of one, comprising:
initiating a read command on a first edge of a clock cycle;
receiving data read from the array of memory cells in a bypass circuit during the clock cycle; and
retrieving the data from the bypass circuit during the clock cycle.

35. The method of claim 34, comprising bypassing first in/first out memory cells used to provide data if the column address strobe latency is greater than one.

36. The method of claim 34, comprising:
generating an inverted clock signal from a data clock signal to retrieve the data from the bypass circuit.

37. The method of claim 36, comprising:
generating a first signal and a second signal from the inverted clock signal to retrieve the data from the bypass circuit.

38. The method of claim 37, comprising outputting a first data bit on a rising edge of the first signal and a second data bit on a rising edge of the second signal.
